(19) United States
(12) Patent Application Publication
(10) Pub. No.: US 2025/0273210 A1
(43) Pub. Date: Aug. 28, 2025

(54) METHODS, SYSTEMS, AND DEVICES FOR MOTOR VEHICLE VOICE-ACTIVATED HORN

(71) Applicant: CERWIN VEGA, INC., Los Angeles, CA (US)

(72) Inventor: Mohammad Hossein Razipour, Los Angeles, CA (US)

(21) Appl. No.: 19/061,972

(22) Filed: Feb. 24, 2025

Related U.S. Application Data
(60) Provisional application No. 63/557,274, filed on Feb. 23, 2024.

(51) Int. Cl. G10L 15/22; B60Q 5/00; G10L 15/06; G10L 15/08

(52) U.S. Cl. CPC G10L 15/22; B60Q 5/00; G10L 15/063; G10L 15/08; G10L 2015/088; G10L 2015/223

(57) ABSTRACT

A motor vehicle voice-activated horn system is disclosed. The system may include a microphone for receiving voice commands; a speech recognition module for converting the voice commands to text; a horn control module for activating a horn, where the horn is activated based on the text; and a processor for coupling the microphone, the speech recognition module, and the horn control module, where the processor may be configured to: receive a voice command from the microphone; convert the voice command to text using the speech recognition module; and activate the horn using the horn control module if the text matches at least one of: a predetermined keyword and a phrase.

### TECHNICAL FIELD

Embodiments relate generally to a horn system on a motor vehicle, and more particularly to a motor vehicle voice-activated horn that is useful in many traffic situations. A voice-activated horn offers a number of safety features due to the fact that the driver does not have to let go of the steering mechanism (e.g., steering wheel) and can use their voice instead to alert of any dangers, help with collision avoidance, alerting pedestrian stepping in front of the vehicle, and provide a robust danger-signaling mechanism in general.

### BACKGROUND

A horn on a motor vehicle is useful in many traffic situations. Typically, the driver is “driving” when he/she decides to “honk the horn” in response to a particular issue. Accordingly, the driver may have to remove their hands from the wheel or quickly take their eyes off the road to operate the horn of the motor vehicle, potentially causing a higher-risk driving situation. It may be beneficial if the driver has the ability to respond to various situations and use the horn in a hands-free environment.

### SUMMARY OF THE INVENTION

A motor vehicle voice-activated horn system is disclose and may comprise: a microphone for receiving voice commands; a speech recognition module for converting the voice commands to text; a horn control module for activating a horn, where the horn may be activated based on the text; and a processor for coupling the microphone, the speech recognition module, and the horn control module, where the processor may be configured to: receive a voice command from the microphone; convert the voice command to text using the speech recognition module; and activate the horn using the horn control module if the text matches at least one of: a predetermined keyword and a phrase.

In one embodiment, the predetermined keyword or the phrase may comprise “honk the horn”. In one embodiment, the processor may be further configured to activate the horn for a predetermined duration of time. In one embodiment, the processor may be further configured to adjust volume of the horn based on an ambient noise level. In one embodiment, the horn may be mounted either on interior or exterior of the motor vehicle.

The motor vehicle voice-activated horn system may be where the motor vehicle voice-activated horn system is in a bicycle, motorcycle, or any motor vehicle. In one embodiment, the speech recognition module may convert a driver's voice command to the text and uses a machine learning algorithm to train the system to recognize the driver's voice command. In another embodiment, the speech recognition module converts a driver's voice command to the text by converting and processing an electrical signal received from the microphone through a comparator chip. In one embodiment, the horn may be deactivated when the motor vehicle is within an area where louder sounds above a sound threshold are prohibited. In one embodiment, the motor vehicle voice-activated horn system may have the horn control module for activating a horn that is programmable to broadcast a variety of types of signals, including a short honk, a long honk, or a series of honks.

In an embodiment of a non-transitory computer readable storage medium having computer program code stored thereon, the computer program code, when executed by one or more processors implemented on a motor vehicle voice-activated horn system, causes to perform a method comprising: receiving, by a microphone, a voice command representing either a predetermined keyword or a phrase spoken by a driver; converting, by the microphone, the voice command to either a digital signal or an electrical signal; generating, by a speech recognition module, a corresponding text associated with the voice command based on either the digital signal or the electrical signal; converting, by a horn control module, the generated text by the speech recognition module to generate a horn control signal; and activating a motor vehicle voice-activated horn based on the horn control signal, causing horn noise.

The method embodiment may further comprise converting, by the speech recognition module, the driver's voice command to the text by using a machine learning algorithm to train the motor vehicle voice-activated horn system to recognize the driver's voice command. The method embodiment may further comprise converting, by the speech recognition module, the electrical signal to the text and process through a comparator chip to activate the motor vehicle voice-activated horn. The method embodiment may further comprise activating the motor vehicle voice-activated horn by a driver while holding a steering wheel. The method embodiment may further comprise activating the motor vehicle voice-activated horn when a driver cannot access a horn button. The method embodiment may further comprise providing communication from the motor vehicle voice-activated horn in a noisy environment where a traditional horn is not heard. The method embodiment may further comprising programming the motor vehicle voice-activated horn to allow generation of a variety of types of signals.

Another embodiment may include a non-transitory computer readable storage medium having computer program code stored thereon, the computer program code, when executed by one or more processors implemented on a motor vehicle voice-activated horn system, causes a motor vehicle voice-activated horn to perform a method comprising: capturing, from a driver, a voice command, representing either a predetermined keyword or a phrase; converting, by a microphone, the voice command to cither a digital signal or an electrical signal; processing the electrical signal via analyzing by a speech recognition module, to generate a signal pattern; training the system to recognize the driver's voice command through a machine learning algorithm; receiving, by a horn control module, an activation signal from the speech recognition module and generating a horn control signal; and activating a motor vehicle voice-activated horn based on the horn control signal, producing horn noise. The method embodiment may further comprise comparing the signal pattern to a predetermined trigger and activating the motor vehicle voice-activated horn upon a match. In one embodiment, the motor vehicle voice-activated horn may be configured to: activate the motor vehicle voice-activated horn while a driver is holding a steering wheel, or when the driver cannot access a horn button; provide communication from the horn in a noisy environment; and program the horn to allow generation of a variety of types of signals.

### BRIEF DESCRIPTION OF DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a block diagram of a voice-activated horn system, according to one embodiment;

FIG. 2A depicts a flow diagram of the operation of the voice-activated horn system, according to one embodiment;

FIG. 2B depicts an alternative flow diagram of the operation of the voice-activated horn system, according to one embodiment; and

FIG. 3 depicts a motor vehicle with a voice-activated horn system installed in the motor vehicle, according to one embodiment.

### DETAILED DESCRIPTION OF THE INVENTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments may be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

A motor vehicle voice-activated horn system is disclosed. The horn may be activated by speaking a predetermined keyword or phrase into a built-in microphone. The voice-activated horn may be implemented in a variety of ways, including using a speech recognition module to convert the driver's voice to text and using a machine learning algorithm to train the system to recognize the driver's voice commands. Or using other electronics such as converting spoken words into a microphone to convert them to electrical signals processed through a comparator chip and associated circuitry to activate the horn. Additionally, the embodiment may provide for the identification of the driver to ensure that the commands are being issued by the driver. The voice-activated horn may be mounted on the exterior or interior of the motor vehicle and may be used in a variety of situations to warn others, get their attention, or signal to other passengers

A motor vehicle voice-activated horn is a system that allows the driver to activate the vehicle's horn by speaking a predetermined keyword or phrase into a built-in microphone. This may be useful in situations where the driver needs to honk the horn but cannot reach for the horn button, such as when they are holding a steering wheel with both hands. In some embodiment, an audio converter may be incorporated in the microphone.

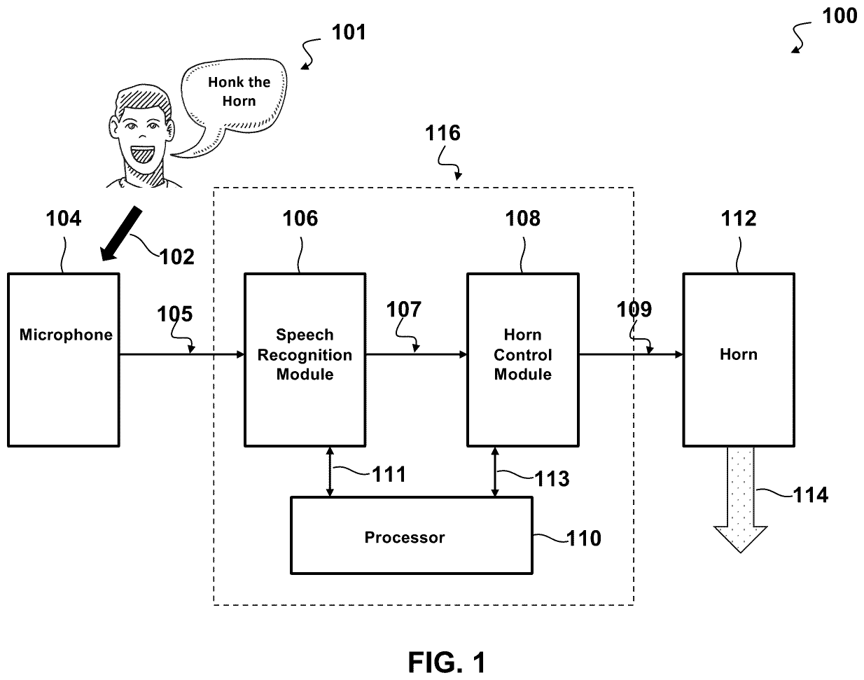

FIG. 1 depicts a block diagram of a system for a voice-activated horn 100, according to one embodiment. FIG. 1 includes a driver 101 that generates voice command 102, which in turn is coupled to microphone 104. Voice command 102 may be referred to as the driver's voice and may comprise a keyword or phrase. In one embodiment, the Microphone 104 may be configured to generate a signal 105, which may be an electrical signal or a digital signal, and which may represent a voice command 102. The electrical signal may be an analog signal. The signal 105 from the microphone 104 is coupled to a speech recognition module 106. The speech recognition module 106 may be configured to convert the signal 105 to be pattern matched to a predetermined command, which may in turn be referred to as the issued command code 107. In the disclosed embodiments, the speech recognition module 106 may be coupled to a horn control module 108 and be configured to transmit the pattern matched predetermined command to the horn control module 108. In one embodiment, the speech recognition module 106 and horn control module 108 may be separately coupled by connections 111 and 113, respectively, to a processor 110, having an addressable memory. Based on issued command code 107 (via the predetermined command), the horn control module 108 may generate a horn control signal 109, which may be transmitted to horn 112 to activate the horn 112 and generate horn noise 114. In one embodiment, the issued command code 107 (via the predetermined command) may comprise a signal pattern.

Per FIG. 1, a horn activation device 116 embodiment may include the speech recognition module 106, the horn control module 108, and processor 110. In some embodiments, the microphone 104 may be integrated with the horn activation device 116. In some embodiments, the microphone 104 may be configured to support other types of audio signals than voice signals. Effectively, the microphone 104 may be an audio converter. In some embodiments, the voice command 102 may be provided by an audio/voice generator.

In the disclosed embodiments, if the voice command 102 matches a predetermined keyword or phrase, then the voice command 102 may be converted to text using the speech recognition module 106, and then the horn 112 is activated using the horn control module 108, causing horn noise 114.

The voice-activated horn 100 may be implemented in a variety of ways. One simple implementation is using microphone 104 as a basic microphone to capture the driver's voice and utilize the speech recognition module 106 to convert the voice to text. The speech recognition module 106 may then be configured to recognize a specific keyword or phrase, such as “honk the horn”, “honk”, “horn”, or “stop.” If the keyword or phrase is recognized, the speech recognition module 106 then transmits a command code 107 using signal pattern to an electronic circuit, e.g., horn control module 108, that activates the horn 112.

Another implementation of the voice-activated horn 100 is to use a machine learning algorithm to train the system to recognize the driver's voice commands. This approach may be more robust to background noise and variations in the driver's voice. In addition, the driver's voice may be used to identify the driver and prevent unauthorized use or accidental activation by other occupants/passengers. In this case, the machine learning algorithm may be implemented by speech recognition module 106, or by processor 110, or by a combination of these elements.

The voice-activated horn 100 may be programmed or configured to broadcast different types of signals, such as a short honk, a long honk, or a series or combinations of honks, where in one embodiment, the period of time for the short honk is shorter than the period of time for a long honk. Processor 110 may be further configured to activate the horn 112 for a predetermined duration of time. The processor 110 may be further configured to adjust the volume of the horn based on the ambient noise level. This programming may be controlled by the processor 110. In some embodiments, the programming instructions may be implemented via a smartphone application that is wirelessly coupled to the processor 110.

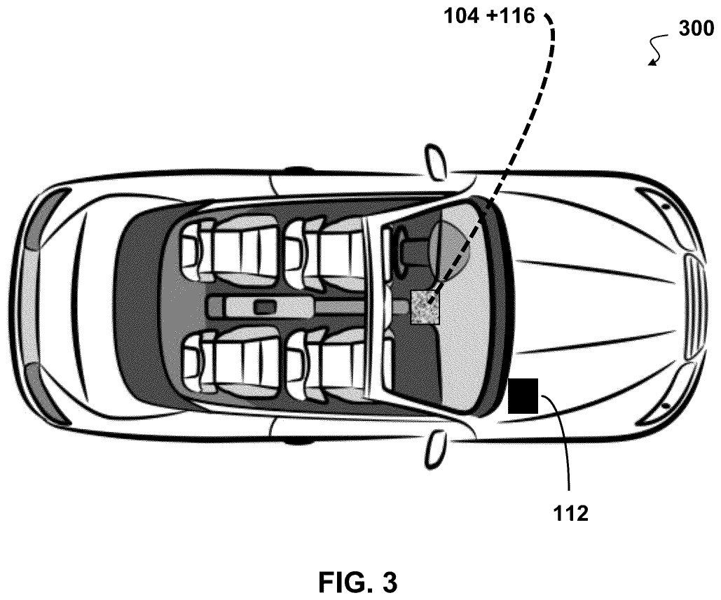

The voice-activated horn 100 may be mounted on the exterior or interior of the motor vehicle. If it is mounted on the exterior, it may be important to choose a location that is protected from the elements. If it is mounted on the interior, it may be important to choose a location that is convenient for the driver to be able to communicate within reach. Additionally, the components of the voice-activated horn 100 may be mounted in different locations. For example, but without limitations, microphone 104, horn activation device 116 and horn 112 may each be mounted in different locations. As discussed, in one embodiments, microphone 104 may be built-in to horn activation device 116. FIG. 3 illustrates one installation embodiment.

The voice-activated horn 100 may be used in a variety of situations. For example, it may be used to warn other drivers of a hazard, such as a pedestrian or cyclist on the road. It may also be used to get the attention of another driver, such as if they are merging into the driver's lane without signaling.

The microphone 104 may be integrated into the vehicle's dashboard or steering wheel. The speech recognition module 106 may be implemented in hardware or software. The electronic circuit of the horn control module 108, that activates the horn 112, may be a simple relay switch circuit or a more sophisticated circuit that is configured to control the volume and duration of the horn blast. The voice-activated horn 100, illustrated in FIG. 1, may be powered by the vehicle's battery or by its own power source. In one embodiment, the horn control module 108 may be configured to be in an active or not active state, where if in a not active state, the horn may be deactivated. The horn 112 may be deactivated when the motor vehicle is within an area where louder sounds are prohibited, e.g., a school, hospital, or government facility. This feature may be implemented by a geo-fence or a smartphone GPS application. In another embodiment, the noise level of the horn noise 114 may be adjusted based on the geo-location of the motor vehicle in that the noise level of the horn noise 114 may be lowered if the vehicle is within a specified distance from a hospital or the noise level of the horn noise 114 may be raised if the vehicle is travelling on a freeway. In another embodiment, the noise level of the horn noise 114 may be adjusted based on the speed of the vehicle, where for example, the horn noise 114 is lower at lower speeds (e.g., less than 35 mile per hour) or higher at higher speeds; where the lower and higher speeds may be determined based on a predetermined threshold speed or an adjustable threshold speed. In another embodiment, the noise level of the horn noise 114 may be adjusted higher or lower based on the surrounding noise level. That is, the system receives as input the surrounding noise level and based on a predetermined threshold, adjusts the volume of the horn 112 when activated. In this way, if the horn 112 is activated in an area that is quiet (noise level is low), the horn 112 may also be activated at a lower volume of the horn noise 114, and if the horn 112 is activated in an area that is noisy (noise level is high), the horn 112 may be activated at a higher volume to ensure that the intended people (or animals) are able to hear the honk when the horn 112 is activated. The adjustable volume of the horn 112 may be similar to how when a human operator presses the horn more gently, they get a softer honk and presses the horn more aggressively to get an alarming honk.

The voice-activated horn 110 may provide a number of advantages. For example, it is more convenient to use, especially when the driver is holding the steering wheel with both hands. Another example would be that it may be used in situations where the driver would not be able to reach the horn button, such as if they are disabled or if they are carrying something in their hands. Additionally, it may be used in noisy environments where a traditional horn may not be heard. In additional examples, the human error is eliminated with pressing the horn using a pressure that would produce the wrong noise volume or length of horn for the specific circumstance. Finally, in another example, it may be used to send different types of signals, such as a short honk, a long honk, or a series of honks. This may be useful for communicating with other drivers in different situations.

The voice-activated horn 100 may also provide improved safety and convenience for drivers and passengers alike. For example, by allowing drivers to use both hands on the wheel or handlebars, throttle, while twisting the right handgrip to operate the throttle, while using the front brake lever and the rear brake lever or the clutch lever/shift lever.

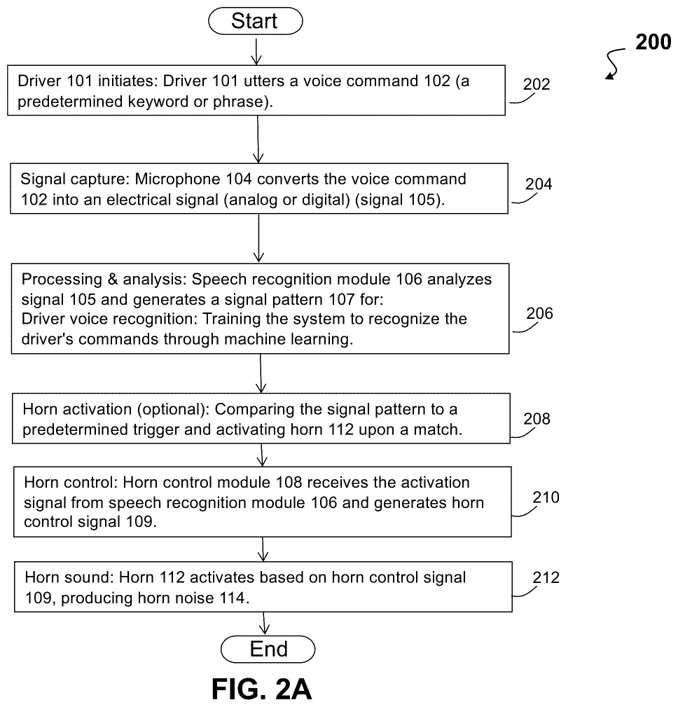

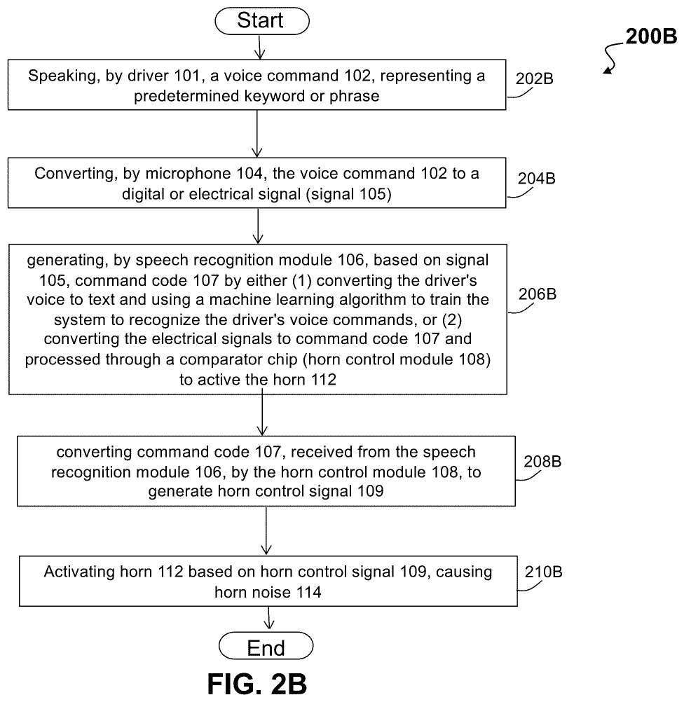

FIG. 2A depicts a flow diagram 200 of the operation of the voice-activated horn 100, according to one embodiment. The operation may include the following steps:

Driver 101 initiates: Driver 101 utters a voice command 102 (a predetermined keyword or phrase). (Step 202)

Signal capture: Microphone 104 converts the voice command 102 into an electrical signal (analog or digital) (signal 105). (Step 204)

Processing & analysis: Speech recognition module 106 analyzes signal 105 and generates a signal pattern (or command code 107) for: Driver voice recognition: Training the system to recognize the driver's commands through machine learning. (Step 206)

Horn activation (optional): Comparing the signal pattern to a predetermined trigger and activating horn 112 upon a match. (Step 208)

Horn control: Horn control module 108 receives the activation signal from speech recognition module 106 and generates horn control signal 109. (Step 210)

Horn sound: Horn 112 activates based on horn control signal 109, producing horn noise 114. (Step 212)

FIG. 2B depicts an alternative flow diagram 200B where the operation may be described as follows:

First, speaking, by driver 101, a voice command 102, representing a predetermined keyword or phrase. (Step 202B) Second, converting, by microphone 104, the voice command 102 to a digital or electrical signal (signal 105) (Step 204B) Third, generating, by speech recognition module 106, based on signal 105, command code 107 by either (1) converting the driver's voice to text and using a machine learning algorithm to train the system to recognize the driver's voice commands, or (2) converting the electrical signals to command code 107 and processed through a comparator chip (horn control module 108) to active the horn 112. (Step 206B) Fourth, converting command code 107, received from the speech recognition module 106, by the horn control module 108, to generate horn control signal 109. (Step 208B) Fifth, activating horn 112 based on horn control module 108, causing horn noise 114. (Step 210B)

The voice-activated horn 100 may be implemented on a bicycle, motorcycle, or any other moving element/vehicle.

The system for a voice-activated horn 100 may be configured to execute one or more of the following: 1) Activate the horn while holding the steering wheel, or when driver cannot access horn button, 2) Provide effectively communication from the horn in a noisy environment, and 3) Program the horn to generate different type of signals. In some embodiments, item (2) may be described as follows: An automatic noise cancellation (ANC) circuitry may be utilized to help reduce outside noise, in simplest terms, the audio from the microphone is mixed with an ANC circuit to help cancel or attenuate the outside noise by nullifying the background sound leaving only the difference of sound which is the spoken voice command this makes it easier for the remaining circuitry to understand also directional microphones could be utilized to focus their sensitivity to the person mouth attenuating nearby extraneous sounds. In some embodiments, item (3) may be described as follows: A phone app could potentially be used to use the spoken word to convert to a digital code that may then be uploaded to the horn circuitry or the spoken word into the microphone when put into a training mode will learn the voice code to activate the horn.

FIG. 3 depicts a motor vehicle 300 with a voice-activated horn 100 installed in the motor vehicle, according to one embodiment. As previously discussed, the voice-activated horn 100 may be mounted on the exterior or interior of the motor vehicle. As illustrated in FIG. 3, horn 112 may be installed exterior of the motor vehicle. Microphone 104 is built-in to horn activation device 116, which comprises the speech recognition module 106, the horn control module 108, and the processor 110. Microphone 104 and horn activation device 116 may be installed interior of the motor vehicle.

As used herein, the terms “device”, “component” and “system” are intended to encompass hardware, software, or a combination of hardware and software. Thus, for example, a system or component may be a process, a process executing on a processor, or a processor. Additionally, a component or system may be localized on a single device or distributed across several devices.

Although various embodiments of the disclosed system for a voice-activated horn 100 have been shown and described, modifications may occur to those skilled in the art upon reading the specification. The present application includes such modifications and is limited only by the scope of the claims.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A motor vehicle voice-activated horn system, comprising:
a microphone for receiving voice commands;
a speech recognition module for converting the voice commands to text;
a horn control module for activating a horn, wherein the horn is activated based on the text; and
a processor for coupling the microphone, the speech recognition module, and the horn control module, wherein the processor is configured to:
receive a voice command from the microphone;
convert the voice command to text using the speech recognition module; and
activate the horn using the horn control module if the text matches at least one of: a predetermined keyword and a phrase.

2. The motor vehicle voice-activated horn system of claim 1, wherein the predetermined keyword or the phrase comprises “honk the horn”.

3. The motor vehicle voice-activated horn system of claim 1, wherein the processor is further configured to activate the horn for a predetermined duration of time.

4. The motor vehicle voice-activated horn system of claim 1, wherein the processor is further configured to adjust volume of the horn based on an ambient noise level.

5. The motor vehicle voice-activated horn system of claim 1, wherein the horn is mounted either on interior or exterior of the motor vehicle.

6. The motor vehicle voice-activated horn system of claim 1, wherein the motor vehicle voice-activated horn system is implemented in a bicycle.

7. The motor vehicle voice-activated horn system of claim 1, wherein the speech recognition module converts a driver's voice command to the text and uses a machine learning algorithm to train the system to recognize the driver's voice command.

8. The motor vehicle voice-activated horn system of claim 1, wherein the speech recognition module converts a driver's voice command to the text by converting and processing an electrical signal received from the microphone through a comparator chip.

9. The motor vehicle voice-activated horn system of claim 1, wherein the horn is deactivated when the motor vehicle is within an area where louder sounds above a sound threshold are prohibited.

10. The motor vehicle voice-activated horn system of claim 1, wherein the horn control module for activating a horn is programmable to broadcast a variety of types of signals, including a short honk, a long honk, or a series of honks.

11. A non-transitory computer readable storage medium having computer program code stored thereon, the computer program code, when executed by one or more processors implemented on a motor vehicle voice-activated horn system, causes to perform a method comprising:
receiving, by a microphone, a voice command representing either a predetermined keyword or a phrase spoken by a driver;
converting, by the microphone, the voice command to either a digital signal or an electrical signal;
generating, by a speech recognition module, a corresponding text associated with the voice command based on either the digital signal or the electrical signal;
converting, by a horn control module, the generated text by the speech recognition module to generate a horn control signal; and
activating a motor vehicle voice-activated horn based on the horn control signal, causing horn noise.

12. The method of claim 11, further comprising converting, by the speech recognition module, the driver's voice command to the text by using a machine learning algorithm to train the motor vehicle voice-activated horn system to recognize the driver's voice command.

13. The method of claim 11, further comprising converting, by the speech recognition module, the electrical signal to the text and process through a comparator chip to activate the motor vehicle voice-activated horn.

14. The method of claim 11, further comprising activating the motor vehicle voice-activated horn by a driver while holding a steering wheel.

15. The method of claim 11, further comprising activating the motor vehicle voice-activated horn when a driver cannot access a horn button.

16. The method of claim 11, further comprising providing communication from the motor vehicle voice-activated horn in a noisy environment where a traditional horn is not heard.

17. The method of claim 11, further comprising programming the motor vehicle voice-activated horn to allow generation of a variety of types of signals.

18. A non-transitory computer readable storage medium having computer program code stored thereon, the computer program code, when executed by one or more processors implemented on a motor vehicle voice-activated horn system, causes a motor vehicle voice-activated horn to perform a method comprising:
capturing, from a driver, a voice command, representing either a predetermined keyword or a phrase;
converting, by a microphone, the voice command to either a digital signal or an electrical signal;
processing the electrical signal via analyzing by a speech recognition module, to generate a signal pattern;
training the system to recognize the driver's voice command through a machine learning algorithm;
receiving, by a horn control module, an activation signal from the speech recognition module and generating a horn control signal; and
activating a motor vehicle voice-activated horn based on the horn control signal, producing horn noise.

19. The method of claim 18, further comprising comparing the signal pattern to a predetermined trigger and activating the motor vehicle voice-activated horn upon a match.

20. The method of claim 18, wherein the motor vehicle voice-activated horn is configured to: activate the motor vehicle voice-activated horn while a driver is holding a steering wheel, or when the driver cannot access a horn button; provide communication from the horn in a noisy environment; and program the horn to allow generation of a variety of types of signals.
